(19) United States
(12) Patent Application Publication
(10) Pub. No.: US 2017/0008747 A1
(43) Pub. Date: Jan. 12, 2017

(54) WINE PRESERVING AND AERATING CONTAINER

(71) Applicant: Sarfaraz K. Niazi, Deerfield, IL (US)

(72) Inventor: Sarfaraz K. Niazi, Deerfield, IL (US)

(21) Appl. No.: 14/794,364

(22) Filed: Jul. 8, 2015

(51) Int. Cl. B67D 1/00; B67D 1/12; B67D 1/08

(52) U.S. Cl. CPC B67D 1/0021; B67D 1/0804; B67D 1/0891; B67D 1/12

(57) ABSTRACT

A non-chemical leaching fluoropolymer container for dispensing, storing and aerating degradable wines.

### BACKGROUND OF THE INVENTION

Wine is produced from the fermentation of plant sugars into alcohol by yeasts. Typically the alcohol content of a wine is in the region of 9-15% alcohol by volume. In addition to the alcohol content wines typically contains a myriad of complex organic compounds that contribute to the taste and flavor of the product. Most but not all of these organic compounds, including the alcohol, may be subject to chemical reaction on exposure to atmospheric oxygen producing a chemically altered product. The chemistry of wine is complex and there is merit, in some cases, of exposing a wine to atmospheric oxygen—generally known as allowing a wine to ‘breathe’.

However, extended exposure to oxygen can result in the wine being ‘oxidized’, and, as a result, becoming unpalatable. Although various reactions may be involved, oxidation does at least affect the alcohol present in the wine in that prolonged exposure to oxygen will result in alcohol being oxidized to aldehydes and ultimately to acetic acid. Thus, wine from a standard 750 ml narrow necked bottle will deteriorate slowly, but appreciably, after opening such that, in most cases, a noticeable drop in quality of a red wine may be perceived after only a few days at the very most. However, aerating wine after opening the bottle improves quality of wine by reduction in acidity or other changes that bring a better taste to palate.

In recent years, there has been a great increase in wine consumption. As more people have become familiar with better quality wines, they have also become sensitive to the degradation which occurs when an open bottle of wine is recorked and reused at a later time. The problem appears to be that when a wine bottle is opened for an initial pouring, oxygen in the air enters the bottle and is trapped there when the bottle is recorked. The trapped oxygen apparently chemically interacts with the wine remaining in the bottle, causing changes in the taste, aroma, and color of the wine. Thus, when the bottle is reopened at a later date, the quality of the wine is found to be significantly degraded.

In U.S. Pat. No. 3,750,915, issued to P. Kearny on Aug. 3, 1973, the problem of wine spoilage by air is addressed. Kearny disclosed a spout including a plug which prevents air from entering the bottle during storage periods. However, the spout is adapted to admit air during the pouring of the wine. This air will be trapped in the bottle during storage when it can chemically interact with the stored wine.

Recently, another device has been marketed in which wine is packaged not in a glass bottle, but in a plastic container having a dispensing spigot near the bottom. As the wine is dispensed from the spigot, atmospheric pressure collapses the plastic container in the region left empty by the poured wine. Since no air is admitted to the container at any time, no deterioration of the wine takes place during pouring or later storage. Although air is excluded by this method, it has been, and continues to be, the case that higher quality wines are bottled and corked in glass bottles, and are not made available in plastic dispensing containers. The reason for this lies in the inevitable leaching of chemicals from plastic container, which is expedited by the presence of alcohol, lack of breathing of wine as it takes place through a traditional cord and the non-esthetic appearance of this type of container.

In U.S. Pat. No. 4,595,121, issued to Sheldon with priority date of 10 Sep. 1984, allows dispensing of wine by pressurizing the bottle using an inert gas. This patent has expired. Recently, a similar device has been marketed in which wine is poured through a sharp needle inserted in the wine bottle, pressurizing the bottle with an inert gas and allowing the wine to drain out by turning the bottle upside down. While this device prevents entering of oxygen in the wine bottle and provides the required protection, the process of operating a compressed gas cylinder, which requires an elaborate and expensive mechanical arrangement, adds to the complexity and cost of preserving wine. There is other prior art that involves similar principle of pressurizing the wine bottle.

The U.S. Pat. No. 4,684,033 describes a method wherein a container is used to remove excess air in the wine bottle to prevent degradation.

The use of bottle pourers is known in the prior art. More specifically, bottle pourers heretofore devised and utilized are known to consist basically of familiar, expected and obvious structural configurations, notwithstanding the myriad of designs encompassed by the crowded prior art which have been developed for the fulfillment of countless objectives and requirements. The art of bottle pourer with aeration systems is also known in the art. The U.S. Pat. No. 8,523,019 describes a combination aerator, pourer, preserver, and stopper for a wines in a complex manner requiring use of inert gases to expel the wine out of the bottle and a plastic device to introduce air into wine as it is poured. The U.S. Pat. No. 8,011, 540 describes an aerator bottle pourer. However, all prior art refers to an added device to provide aeration process with extreme complexity.

There is an unmet need to develop a wine holding container that will not interact with wine, will be mostly impermeable to oxygen, will have extremely low surface tension, will not leach any chemicals into wine, yet be flexible and collapsible to allow pouring of wine without any need to pressurize the bottle; additionally, the container must be able to prevent an ingress of oxygen while wine is dispensed out of the container. Ideally, the container will provide additional benefit of aerating wine while it is being poured without adding any additional device to the pouring device.

### SUMMARY OF THE INVENTION

In accordance with the illustrated preferred embodiments, the present invention provides a container for dispensing degradable wines, from a flexible, collapsible, non-leaching fluoropolymer container, while insuring that gaseous contaminants such as oxygen cannot enter the container substantially. During storage between dispensing events, oxygen is still excluded from the container, once the dispensing port is closed. In addition, the invention provides a simple method of aerating wines as they are poured, without adding any additional device to the container. This concept of aeration is based on the Venturi effect. As wine flows through a tube, its velocity increases resulting in a drop in pressure, causing air to draw into liquid from the holes in the tube through which wine is flowing. This produces and instant aeration of wine.

### DESCRIPTION OF THE DRAWINGS

FIG. 1 shows a containing a degradable wine, the container having a dispensing tube and a clamp attached and the holes in the tube to aerate the wine being poured out.

### DETAILED DESCRIPTION OF THE PREFERRED EMBODIMENT

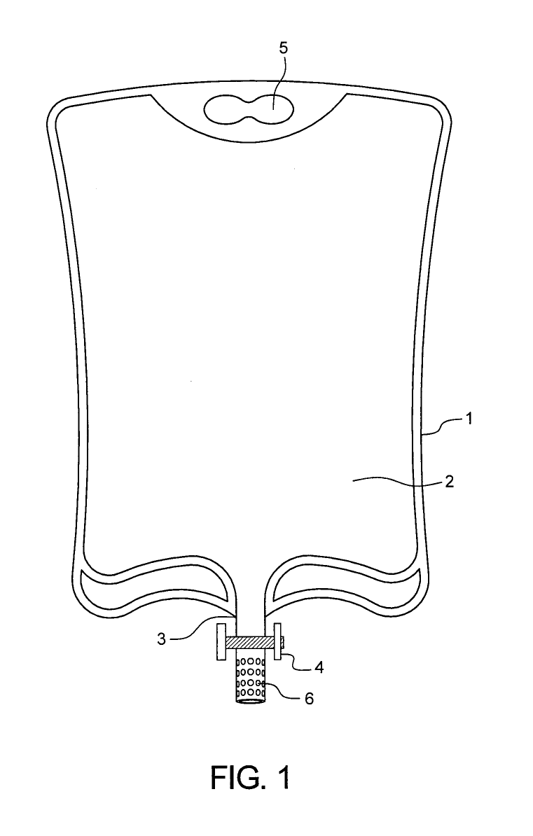

In FIG. 1, there is shown a flexible and collapsible bag 1, completely filled with a degradable wine 2. For purposes of this disclosure, a “degradable wine” is taken to be a liquid intended for human consumption whose taste, color, appearance, or texture would be altered by contact with liquid or gaseous substances, including air or oxygen. A tube 3 is fitted into the bag container 1, to which is a clamp 4 is applied that will hermetically seal the tube 3 when closed. A means of hanging the container 5 that allows upside down orientation of the bag by attaching it to any support element, such as a hook. A plurality of holes 6 are provided in that part of the tube between the clamp and the pouring end.

Wines are packaged in smaller containers because it degrades upon opening the container to reduce losses of wine quality if it had to be stored for a longer time after opening the container. Even at 750 mL size, the most popular size, it is often necessary to keep an opened bottle at least for a short time; several devices are available to selectively pour a small portion of wine from a bottle, apply vacuum to opened bottle to reduce degradation, use a pressurized system to expel only desire quantity of wine from a sealed bottle, etc. No prior art points to pouring of wine from a larger container without affecting the storage quality without utilizing complex devices, methods and techniques that add substantial cost to the handling of wines.

As an alternative to the use of a wine bottle, the wine cask has been developed and used successfully, also known as the container in box (BIB). A wine cask consists of a flexible metalized polymer container holding wine attached to a dispensing tap. In use, a wine cask has a limited life span of around 9 months, as the polymer container is to some degree permeable to oxygen. The BIB is the most common and popular bulk liquid storage packaging that offers intermittent liquid dispensing. The principle of operation of the BIB involves the liquid being contained within a collapsible container that requires gravity to push the contents out of a dispensing tap.

There are several limitations to the BIB. These are:

(a) Liquids sensitive to oxidation have a limited shelf life in the BIB due to oxygen ingress through the collapsible container during storage. Forty percent of the oxygen ingress in the BIB occurs as a result of direct oxygen permeability into the stored liquid through the container itself.

(b) Oxidation further increases by another 60% when the consumer begins dispensing liquid as a result of oxygen ingress through the dispensing tap.

(c) Microbial contamination can enter through the dispensing tap during use.

(d) Leaching of chemicals from the containers is a serious issue that has not been dealt with earlier. The ability of packaging systems to contribute leached substances to liquids is well established. This is further exacerbated when the liquid contains alcohol. The leachable include plasticizers, antioxidants, lubricants, stabilizers, binding agents, ink components, and many other chemicals that are found in the plastic containers currently used in BIB packaging. Given the complexity of the reactions that take place when the wine ages, presence of any of these chemicals can significantly alter the structure of wine, leading to rapid degradation and loss of flavor and taste. The same applies to any other plastic components used in BIB, including the dispensing ports. Since red wine continues to age in the final container and is allowed to stay in there often for years, the cumulative effect of storing wines in a plastic container that would leach will be disastrous. It is for this reason that only cheaper wines are provided in BIB packaging.

Of all polymers available, the fluoropolymers are unique in that they do not need any additive to form a surface and are thus of non-leaching type; they also have very high resistance to permeability of gases, have high strength and durability. They are also resistant to acidic pH (which is the case with red wines), and can last for a very long time without deterioration. To date, there is no prior art on using a fluoropolymer flexible container to store wines or other degradable wines.

Wines contained in fluoropolymer containers offer a new opportunity for cost-effective methods of preventing degradation while the wines are in use.

In one embodiment, the present invention offers an extremely cost-effective solution to storage and serving of wines that are subject to degradation if exposed to oxygen.

In another embodiment, the present invention offers portioning the contents of a wine without having the need to consume the whole bottle.

In another embodiment, the present invention offers a possibility to order smaller portions of high-end wines.

In another embodiment, the present invention offers a long-term storage of degradable wines without affecting their quality.

In another embodiment, the present invention improves the taste of wine by providing an instant aeration as the wine is poured out, combining several useful functions in a single invention.

The use of container in a proper manner requires hanging the container with the pouring end facing downward, opening the clamp to allow flow of wine and collecting wine in a glass, closing the clamp securely before removing the container from a hanging position.

The foregoing descriptions of specific embodiments of the present invention are presented for the purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. (canceled)

2. The container of claim 4, wherein the fluoropolymer is polytetrafluoroethylene (PTFE), perfluoroalkoxy (PFA), or fluorinated ethylene propylene (FEP).

3. (canceled)

4. A wine holding and pouring container comprising:
a) a flexible, collapsible fluoropolymer bag completely filled with a wine;
b) at least one flexible fluoropolymer tube having a wall, a proximal end connected to the bag and a distal end in communication with the outside;
c) a clamp to hermetically close and open the tube;
d) a hanging mean to dispose the bag in a vertical position.

5. The container of claim 4, wherein, the tube wall comprises a plurality of holes in the wall of the tube between the clamp and the distal end of the tube.

6. The container of claim 4, wherein the clamp is a compression valve.

7. The container of claim 4, wherein the wine is poured out of the container by disposing the bag in a vertical position by connecting the hanging means of the container to an external support, opening the clamp and allowing the wine to pour under gravity effect through the distal end of the tube and closing the clamp upon completion of the pouring of wine.
